(19) United States
(12) Patent Application Publication
(10) Pub. No.: US 2026/0264606 A1
(43) Pub. Date: Sep. 10, 2026

(54) STEERING WHEEL

(71) Applicant: TOYODA GOSEI CO., LTD., Kiyosu-shi (JP)

(72) Inventors: Kazuma MURAMATSU, Kiyosu-shi (JP); Akitoshi NAGANAWA, Kiyosu-shi (JP)

(21) Appl. No.: 19/543,950

(22) Filed: Feb. 19, 2026

(30) Foreign Application Priority Data
Mar. 10, 2025 (JP) 2025-037546

(51) Int. Cl. B60Q 3/283; B60Q 3/62; B62D 1/06; F21V 8/00

(52) U.S. Cl. CPC B60Q 3/283; B60Q 3/62; B62D 1/06; G02B 6/005

(57) ABSTRACT

A steering wheel comprises: a gripping portion; a substrate disposed in the grip portion, wherein a light emitting element is provided on the substrate; and a lens unit disposed in the grip portion, wherein the lens unit comprises a light transmitting portion that has a transmissivity to a light emitted from the light emitting element and emits the light to the outside of the grip portion, wherein the lens unit accommodates the substrate such that an inner surface of lens unit faces the substrate. The lens unit has an outer surface on a side facing a user of the steering wheel, wherein the outer surface is composed of a contiguous surface which includes a part of a surface of the light transmitting portion.

### CROSS REFERENCE TO RELATED APPLICATIONS

The present application claims priority from Japanese patent application No. 2025-37546 filed Mar. 10, 2025, the disclosure of which is incorporated in its entirely by reference into the present application.

### BACKGROUND

### Field

This disclosure relates to the steering wheel.

### Related Art

Conventionally, a steering wheel has been proposed which includes a device that emits light such as visible light or infrared light from a position visible to the driver. For example, the steering wheel of JP2024-504088A, (a) a substrate on which a light emitting element such as a LED is provided, (b) a holding member for holding the substrate, (c) a member which is disposed in the opening provided in the holding member, guides the light emitted from the light emitting element to the outside, and closes the opening (hereinafter, referred to as a lens).

However, the steering wheel of JP2024-504088A may include (i) a gap between the lens and the opening or (ii) a deviation in the height direction when the lens and the opening are assembled. In such a case, there is a possibility that the driver feels uneven when touching those parts and feels uncomfortable. Therefore, a technique that can suppress the possibility of feeling unevenness when a driver touches the steering wheel equipped with a device that irradiates light is desired.

### SUMMARY

The present disclosure has been made in order to address at least a part of the above-mentioned problems, and it is possible to realize the present disclosure as the following aspect.

As one aspect of the present disclosure, a steering wheel is provided. A steering wheel in this aspect comprises: a gripping portion; a substrate disposed in the grip portion, wherein a light emitting element is provided on the substrate; and a lens unit disposed in the grip portion, wherein the lens unit comprises a light transmitting portion that has a transmissivity to a light emitted from the light emitting element and emits the light to the outside of the grip portion, wherein the lens unit accommodates the substrate such that an inner surface of lens unit faces the substrate. The lens unit has an outer surface on a side facing a user of the steering wheel. The outer surface is composed of a contiguous surface which includes a part of a surface of the light transmitting portion.

### BRIEF DESCRIPTION OF THE DRAWINGS

FIG. 1 is a plan view showing an external view of the steering wheel as an embodiment of the present disclosure;

FIG. 2 is a plan view showing the external shapes of the steering wheel with the outer skin layer and the lens unit and the light guide removed;

FIG. 3 is an exploded perspective view showing a detailed configuration of the illumination device;

FIG. 4 is a sectional view showing a cross section of the steering wheel;

FIG. 5 is a perspective view showing the detailed configuration of the illumination device of the second embodiment;

FIG. 6 is a sectional view showing a cross section of the steering wheel of the second embodiment;

FIG. 7 is a sectional view showing a cross section of the steering wheel of the third embodiment;

FIG. 8 is a sectional view showing a cross section of the steering wheel of the fourth embodiment;

FIG. 9 is a sectional view showing a cross section of the steering wheel of the fifth embodiment;

FIG. 10 is a sectional view showing a cross section of the steering wheel of the sixth embodiment; and

FIG. 11 is a sectional view showing a cross section of the steering wheel of the seventh embodiment.

### DETAILED DESCRIPTION

### A. First Embodiment:

### A1. Overall configuration of the steering wheel 100

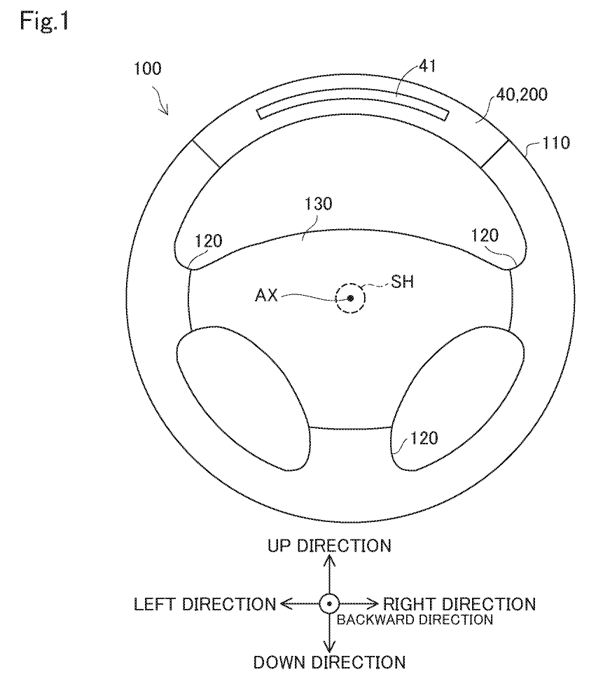

FIG. 1 is a plan view showing the external aspect of the steering wheel 100 as an embodiment of the present disclosure. The steering wheel 100 is located and used in the driver's seat of the vehicle. Vehicles include, for example, engine-equipped vehicles, hybrid vehicles (HEV), plug-in hybrid vehicles (PHEV), electric vehicles (BEV), fuel-cell vehicles (FCV), and the like. The steering wheel 100 is part of a steering system operated by the driver of the vehicle. FIG. 1 shows the steering wheel 100 of the state in which the steering wheel 100 is connected with the steering shafts SH in the vehicle and the vehicle is driven straight ahead (hereinafter also referred to as "reference state"). Further, in FIG. 1, the external configuration of the side facing the driver in the steering wheel 100 ("the backward direction" side described later) is represented. The steering wheel 100 is configured to be rotatable about the central axis AX of the steering shafts SH. The revolution of the steering wheel 100 is transmitted to a steering gearbox (not shown) via the steering shafts SH.

In this embodiment, the direction along the central axis AX of the steering shafts SH is referred to as the "longitudinal direction" (the forward direction and the backward direction) in association with the traveling direction of the vehicle. Of the directions perpendicular to the central axis AX, the direction overlapping with the vertical direction (vertical upward and vertical downward) as viewed from the driver is called the "vertical direction". Of the directions perpendicular to the central axis AX, the direction parallel to the lateral direction (width direction) of the car is referred to as the "lateral direction."

The steering wheel 100 comprises a ring-shaped gripping portion 110, a boss 130 located in a generally central portion of the gripping portion 110, three spoke 120, and an illumination device 200 located in a portion of the gripping portion 110.

The gripping portion 110 is grasped by the driver when the steering wheel 100 is operated. In the present embodiment, the shape of the gripping portion 110 is substantially annular shape. The central axis of the gripping portion 110 coincides with the central axis AX of the steering shafts SH. The shape of the gripping portion 110, instead of the substantially annular shape, may be any shape such as a polygonal shape or an elliptical shape, also may be an asymmetrical shape such as a so-called D-shape. Furthermore, the shape of the gripping portion 110 is not limited to an annular, it may be any shape formed by a plurality of parts provided at a position apart from each other. As described below, the gripping portion 110 is configured such that a plurality of members are superimposed in the thickness direction. The outermost layers are formed by the outer skin layer (the outer skin layer 80 described later) formed by leather members. Incidentally, in FIG. 1, the steering wheel 100 with the outer skin layer 80 removed is illustrated. Removing the outer skin layer 80 exposes the lens unit 40 which is a part of the illumination device 200 provided in the gripping portion 110 and described later.

Three spoke 120 couple the gripping portion 110 and the boss 130. The boss 130 corresponds to the connecting point when the steering wheel 100 is connected to the steering shafts SH. The interior of the boss 130 houses a folded airbag and inflator, both not shown. Incidentally, the boss 130 may contain temperature control circuitry constituting the heater device or various sensor devices for detecting the room temperature or the grip of the gripping portion 110 by the user. The three spoke 120 and the boss 130 may be provided with various operation buttons for operating a navigation device, an audio device, or the like mounted on the vehicles.

The illumination device 200 is exposed to light. In the present embodiment, the light emitted by the illumination device 200 is visible light and infrared light. By emitting visible-light from the illumination device 200, various information can be informed to the driver. For example, by emitting lights of various colors or a blinking light, it is possible to notify some information to the driver. Specifically, by emitting red lights, it is possible to urge the driver to grasp the steering wheel 100. In addition, by emitting infrared light from the illumination device 200, a part of the driver's body can be captured neatly by infrared cameras in a dark vehicle interior at night.

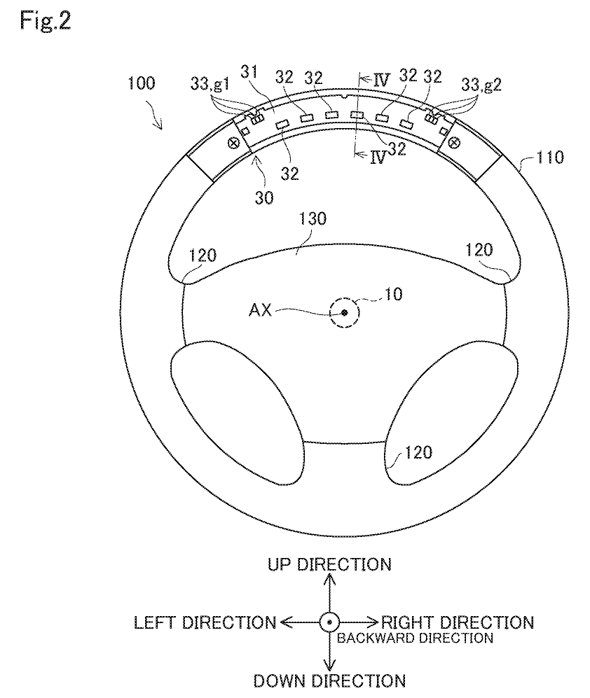

FIG. 2 is a plan view showing the external aspect of the steering wheel 100 in addition to the outer skin layer 80, with the lens unit 40 and the light guide 20 removed. As shown in FIG. 2, when the lens unit 40, the light guide 20 and the outer skin layer 80 are removed, the light-emitting unit 30 which is one of the elements constituting the illumination device 200 is exposed. The light-emitting unit 30 includes the substrate 31 and a plurality of light emitting elements provided on the face of the substrate 31. A "plurality of light emitting elements" includes, in this embodiment, a plurality of the first LED 32 and a plurality of the second LED 33. The substrate 31, as viewed from the driver, has a curved arc and strip-shaped external form along the circumferential direction of the gripping portion 110 (hereinafter, simply referred to as "circumferential direction"). In the following, the radial direction of the gripping portion 110 (direction perpendicular to the central axis AX) is simply referred to as a "radial direction". The radial direction of the gripping portion 110 can also be called the radial direction of the steering wheel 100. The plurality of the first LED 32 are disposed in the positions close to the end of the down direction on the backward direction side of the surface of the substrate 31. The plurality of the first LED 32 are spaced apart by a predetermined distance from each other along the circumferential direction. The first LED 32 emits visible light. In the present embodiment, as the first LED 32, visible light LED capable of emitting red light and green light and blue light is used. A plurality of the second LED 33 form two grouped g1, g2 which are spaced apart from each other. Every grouping g1, g2 consists of a plurality of circumferentially adjoining the second LED 33. Both of the two grouped g1, g2 are located close to the up direction end of the backward direction face of the substrate 31. These two grouped g1, g2, when viewed along the circumferential direction, are spaced apart from each other so as to sandwich the plurality of the first LED 32. The second LED 33 emits infrared light.

### A2. Detailed configuration of the illumination device 200

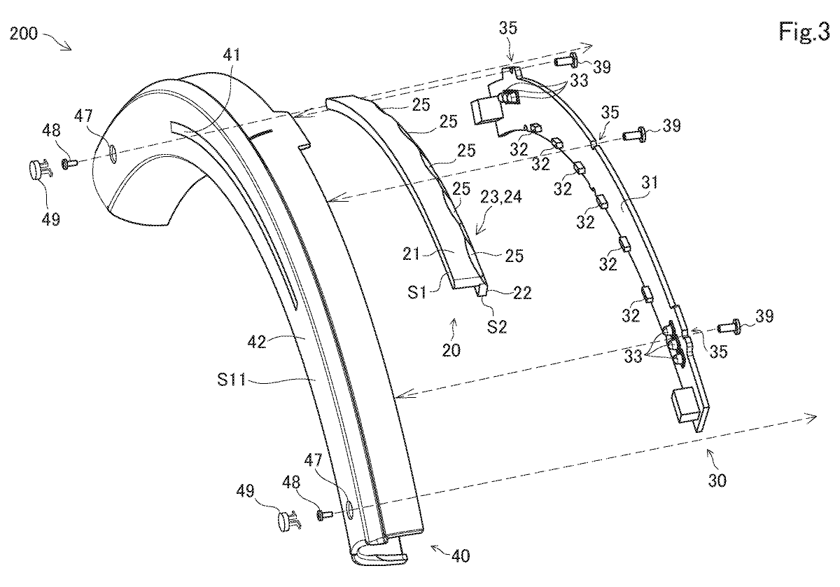

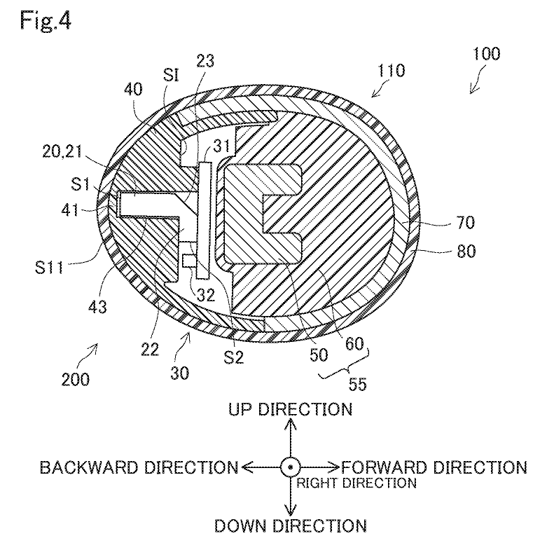

FIG. 3 is an exploded perspective view showing a detailed configuration of the illumination device 200. FIG. 4 is a sectional view showing a cross section of the steering wheel 100. FIG. 3 corresponds to an exploded perspective view of the illumination device 200 from approximately the rear side toward the front side. FIG. 4 shows IV-IV cross section shown in FIG. 2.

As shown in FIG. 3, the illumination device 200 has the lens unit 40 and the light guide 20, in addition to the light-emitting unit 30 described above. The illumination device 200 has a structure in which the light-emitting unit 30 and the lens unit 40 are assembled in the longitudinal direction with the light guide 20 sandwiched between them, forming an integrated structure. The illumination device 200 is mounted and supported by the support portion 55 to be described later.

### Lens unit 40

As shown in FIG. 1 and FIG. 3, the lens unit 40, as viewed from the driver, has a curved arc and strip-shaped external form along the circumferential direction of the gripping portion 110. Further, as shown in FIG. 4, when viewed from the longitudinal section, the backside of the lens unit 40 has an external form of approximately hemispherical. As shown in FIG. 4, the lens unit 40 houses the substrate 31 in such a manner that its inner surface SI faces the substrate 31. That is, the lens unit 40 has a housing function for accommodating the substrate 31. In this specification, the state where a component A has an internal cavity and another component B is disposed within that cavity, as well as the state where a component A has a recess and another component B is disposed within that recess, shall both be described as “component A accommodates component B.” The inner surface SI of the lens unit 40 is the portion of the outer surface of the lens unit 40 that is located on the side of the center axis of the gripping portion 110. The lens unit 40 has a transmissivity to the light emitted from the plurality of the first LED 32 and the plurality of the second LED 33 (hereinafter, simply referred to as "emitted light") and emits the emitted light to the outside. In this specification, the property of an object A to transmit a certain light X is expressed as “object A has transmissivity to light X.”

The lens unit 40 comprises the light transmitting portion 41 and the low transmissivity portion 42. The light transmitting portion 41 is transparent to the emitted light and emits the emitted light to the outside of the steering wheel 100 through the outer skin layer 80. As shown in FIG. 3, the light transmitting portion 41 is provided at a position corresponding to the first light passage 21 to be described later in the light guide 20. In the present embodiment, the light transmitting portion 41 has a transmissivity of approximately 25% for visible light emitted from a plurality of the first LED 32 Incidentally, the transmittance of the light transmitting portion 41 is not limited to 25%, but may be any transmittance higher than 0%.

The low transmissivity portion 42 corresponds to the other parts except the light transmitting portion 41 in the lens unit 40. Thus, the low transmissivity portion 42 adjoins the light transmitting portion 41. The low transmissivity portion 42 has a lower degree of transmission of visible light emitted from the plurality of the first LED 32 than the light transmitting portion 41. More specifically, in the present embodiment, the transmissivity to the visible-light of the low transmissivity portion 42 is 5%. Note that the transmittance is not limited to 5%, and may be any transmittance lower than the transmissivity to the light transmitting portion 41. The light transmitting portion 41 and the low transmissivity portion 42 have transmittances of approximately 90% for infrared light emitted from the plurality of the second LED 33.

In this embodiment, the lens unit 40 is formed of polycarbonate (PC) resin. In place of the polycarbonate resin, it may be formed of an arbitrary resin material having light transmissivity such as an acrylic resin. In addition, it may be formed of glass rather than resin. In this embodiment, the light transmitting portion 41 and the low transmissivity portion 42 are formed by two color molding of polycarbonate resin. In other words, one PC resin material is colored in black, for example, so as to reduce the degree of light transmissivity, and the other PC resin material is set as a transparent material, and these materials may be used for dual color molding. It is to be noted that, in place of the two-color molding, the transmissivity to the low transmissivity portion 42 may be suppressed to be lower than that of the light transmitting portion 41 by sticking an ultrathin black film on the surface of the low transmissivity portion 42 or by applying a black coating material.

The outer surface S11 on the backward direction side of the lens unit 40 is the side facing the user, i.e. the driver, of the steering wheel 100. As shown in FIG. 3 and FIG. 4, the outer surface S11 is composed of a contiguous surface (hereinafter, also referred to as "contiguous surface") including a part of the light transmitting portion 41. In the present embodiment, the contiguous surface constituting the outer surface S11 include the surface of the low transmissivity portion 42 in addition to the surface of the light transmitting portion 41. The contiguous surface is a smooth curved surface. The above-described "contiguous" means that there is no unevenness or the groove at the boundary of regions partitioned into each other on the way or at the boundary where different parts are adjacent to each other, and that there is a smooth and a certain condition.

### Light guide 20

The light guide 20 guides light (visible light) emitted from the first LED 32 to the lens unit 40. In this embodiment, the light guide 20 is formed of polycarbonate (PC) resin. In place of PC resin, it may be formed of an acrylic resin or glass. As shown in FIG. 3 and FIG. 4, the light guide 20 has an external shape cross-sectional shape along the central axis AX is substantially L-shaped. Further, the light guide 20 has an arcuate appearance in accordance with the arrangement position of the plurality of the first LED 32, when viewed from the driver.

As shown in FIG. 3 and FIG. 4, the light guide 20 includes the first light passage 21, a second optical passage portion 22, and the deflection portion 23. The first light passage 21 includes the first emission surface S1 from which visible light is emitted. The visible light is emitted from the light guide 20 to the lens unit 40. The first light passage 21 extends along the direction from the surface of the substrate 31 (the backward direction side surface) toward the lens unit 40. From the first emission surface S1 diffused light having a spread is outputted as the emitted light. Emitted light emitted from the first emission surface S1 is received by the lens unit 40, and emitted to the outside through the outer surface S11 and the outer skin layer 80 of the light transmitting portion 41.

The second light passage portion 22 has the incidence surface S2 where the visible light outputted from the first LED 32 is incident. As shown in FIG. 4, the incidence surface S2 is located the up direction to the first LED 32. Therefore, the incidence surface S2, visible light is incident upward from the first LED 32. The deflection portion 23 connects the first light passage 21 and the second light passage portion 22. The deflection portion 23 reflects the visible light guided by the second light passage portion 22 to input the visible light to the first light passage 21. More specifically, the visible light strikes the incidence surface S2 of the second light passage portion 22 and travels upward. The deflection portion 23 deflects the visible light so that it travels forward and inputs it into the first light passage 21. As shown in FIG. 3, the deflection portion 23 has a deflection surface 24 that deflects visible light. A plurality of the diffusion portion 25 are formed in the deflecting surface 24. Each the diffusion portion 25 is disposed at a corresponding position in front with respect to each the first LED 32. Every diffusion portion 25 has a recess-like construction which is partially chamfered deflecting surface 24. Specifically, the diffusion portion 25 has a depression-like construction in which the position corresponding to the first LED 32 in the forward direction is the most concave, and the depth gradually decreases as it approaches the position corresponding to the next first LED 32 along the circumferential direction. Further, the width of the diffusion portion 25, i.e. the vertical dimension of the diffusion portion 25 is largest at the position corresponding to the first LED 32 in the up direction (more precisely, the direction toward the radially outer direction). The width of the diffusion portion 25 gradually decreases as it approaches the position corresponding to the next first LED 32 along the circumferential direction. By the deflection portion 23 having such a construction, visible light outputted from each of the first LED 32 as point light source is diffused in the circumferential direction and the vertical direction when deflected in the deflection portion 23. As shown in FIG. 3, in the surface of the forward direction of the lens unit 40, the groove 43 is provided with the depth direction being the longitudinal direction. The first light passage 21 of the light guide 20 is accommodated in the groove 43.

As shown in FIG. 3, the light-emitting unit 30 is fixed to the lens unit 40 by the screws 39 disposed to pass through a cutout 35 provided in the edge of the up direction of the substrate 31. The lens unit 40 is provided with the screws hole (not shown) for receiving the screws 39. In other words, in this embodiment, the lens unit 40 supports the substrate 31. The illumination device 200 integrated in this way is screwed to the support portion 55 shown in FIG. 4. Specifically, as shown in FIG. 3, in the left and right end portions in the circumferential direction in the lens unit 40, each the through hole 47 is provided. The screws 48 is inserted to each of the two through hole 47 and screwed into the screws hole (not shown) in the support portion 55 so that the illumination device 200 is fixed to the support portion 55. Both of the two through hole 47 are blocked by the lid unit 49. The lid unit 49 is provided with the engaging claw. When the engaging claw is fitted into the groove (not shown) provided on the inner peripheral surface of the through hole 47 in the lens unit 40, the lid unit 49 is fixed.

### A3. Detailed configuration of the gripping portion 110

In the gripping portion 110, the cross-sectional configuration of the other portions except the portion, where the illumination device 200 is mounted, differ from the cross-sectional configuration of the portion where the illumination device 200 is mounted (shown in 4) in that the illumination device 200 is not mounted. The other cross-sectional configuration of the other portions is same as the cross-sectional configuration of the portion where the illumination device 200 is mounted.

As shown in FIG. 4, the gripping portion 110 includes a support 55, the element layer 70, and the outer skin layer 80 in addition to the illumination device 200 described above.

Support 55 supports the illumination device 200. The support 55 comprises the core metal 50 and the shock absorbing unit 60.

The core metal 50 is a metallic and structural member of the gripping portion 110. In the present embodiment, the core metal 50 is made of aluminum-alloy. Incidentally, instead of an aluminum alloy, or a magnesium alloy, may be formed the core metal 50 by any type of metal such as steel. The shock absorbing unit 60 is positioned to cover the entire the core metal 50 and forms the core of the gripping portion 110. The shock absorbing unit 60 is formed of a soft synthetic resin having a cushioning property. Specifically, in this embodiment, the shock absorbing unit 60 is formed of a soft foam material such as foamed polyurethane. The shock absorbing unit 60, the through hole (not shown) the screws 48 described above penetrates is provided. Further, in the core metal 50, the screws hole (not shown) in which the screws 48 is screwed is formed.

The element layer 70 partially covers the shock absorbing unit 60. The element layer 70 is a heating wire which constitutes a heater device, or a layer in which an electrode for detecting gripping is provided. For example, it is formed by a conductive cloth in which a surface treatment such as carbon coating or metal plating is applied to a textile cloth. As shown in FIG. 4, in the part where the illumination device 200 is mounted in the gripping portion 110, the element layer 70 also covers a portion of the lens unit 40. The outer surface of the element layer 70 and the outer surface of some of the lens unit 40 form a roughly contiguous surface.

The outer skin layer 80 continuously covers the outer surface of the element layer 70 and the outer surface S11 of the lens unit 40. The outer skin layer 80 is formed of a leather member having transmissivity to emitted light. In the present embodiment, the leather member is composed of natural leather such as a top leather or a split leather divided from the top leather. Note that the leather member may be made of any kind of leather material, such as synthetic leather or artificial leather, instead of natural leather.

### A4. Method for producing the steering wheel 100

Method (assembly method) for producing the steering wheel 100 having the configuration described above will be described. First, the light guide 20, the light-emitting unit 30, and the lens unit 40 are manufactured, respectively. Next, the light guide 20 and the light-emitting unit 30 are placed within the light guide 40 so that the light guide 20 and the light-emitting unit 30 sandwich the light guide 20. Then the light-emitting unit 30 is screwed to the lens unit 40 with the screw 39. Through such procedures, the lens unit 200 is produced. Next, the core metal 50 is formed. The shock absorbing unit 60 and the element layer 70 is produced so as to surround the core metal 50. Hereinafter, the member obtained in this way is referred to as a "handle material". Formation of the handle material may be realized, for example, by insert molding. Subsequently, the illumination device 200 is fixed to the support portion 55 using the screws 48. Subsequently, the leather member is wound around the outer surface of the member in which the handle material and the illumination device 200 are integrated to form the outer skin layer 80. The outer skin layer 80 may be formed, for example, by winding a plurality of parts of the leather member in the circumferential direction, respectively. In this way, the steering wheel 100 is completed. In addition to the above-described procedures, there are procedures for accommodating an air bag or an inflator (not shown) in the boss 130, but these procedures will not be described.

According to the steering wheel 100 in the first embodiment described above, the lens unit 40 has the outer surface S11 on the side facing the user (i.e., the driver) of the steering wheel 100. The outer surface S11 is composed of a contiguous surface that includes part of the surface of the light transmitting portion 41. Therefore, even when the outer skin layer 80 is the outermost layer along such the outer surface S11 is formed, it is possible to prevent the driver from feeling irregularities when touching the gripping portion 110.

The lens unit 40 also supports the substrate 31. Therefore, the lens unit 40 as a single part can realize both of (i) a portion having a function for emitting light to the outside of the gripping portion 110 and a function for accommodating the substrate 31 (housing function), and (ii) a portion having a function of supporting the substrate 31. Therefore, as compared with the configuration in which these functions are realized by different parts, the number of components can be reduced, the assembly operation can be simplified, and the weight of the steering wheel 100 can be reduced.

Further, both of the surface of the light transmitting portion 41 and the surface and the low transmissivity portion 42 form a part of the contiguous surface, and are arranged in contact with each other in the contiguous surface. Therefore, it is possible to suppress the unevenness occurs at the boundary between the light transmitting portion 41 and the low transmissivity portion 42.

It also comprises the outer skin layer 80 which has transmissivity to the light to form the outermost layers in the gripping portion 110. Therefore, the tactile feeling can be improved by the outer skin layer 80, also can improve the decorative property.

### B. Second Embodiment

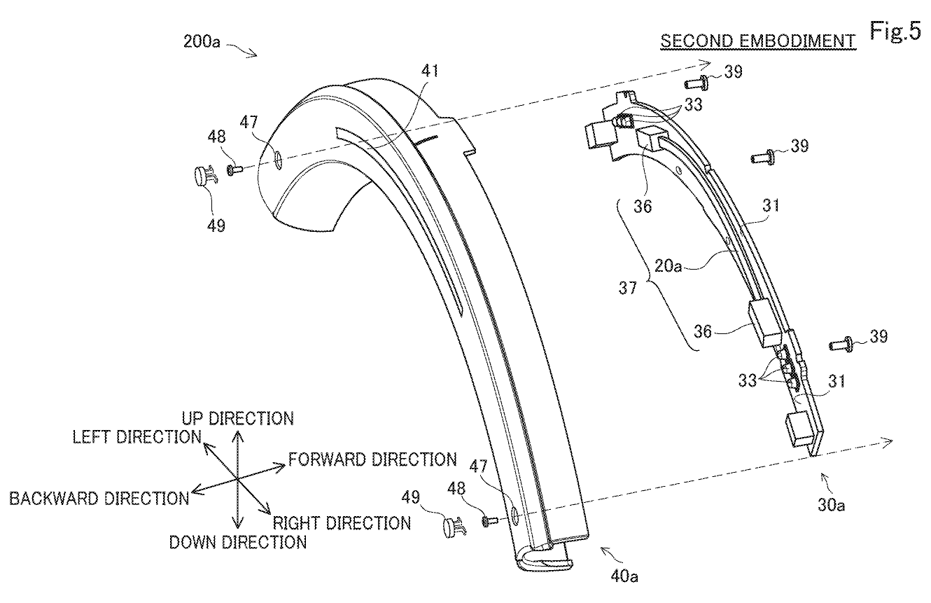

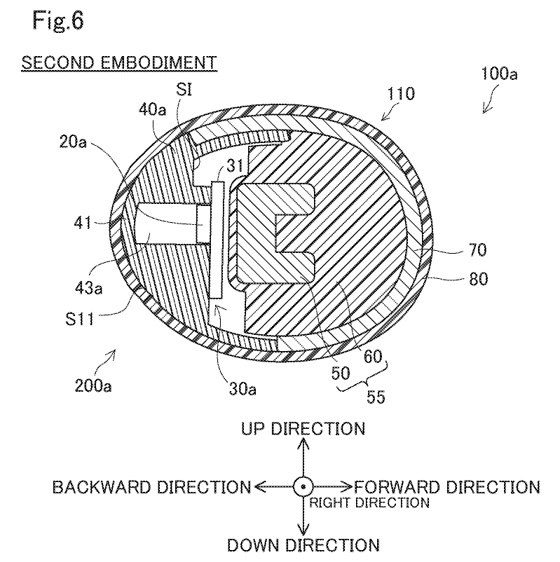

FIG. 5 is a perspective view showing a detailed configuration of the illumination device 200a of the second embodiment. FIG. 6 is a sectional view showing a cross section of the steering wheel 100a of the second embodiment. FIG. 6 shows the cross-section of the steering wheel 100a at the same position as FIG. 3.

The steering wheel 100a in the second embodiment differs from the steering wheel 100 in the first embodiment in that it has the illumination device 200a instead of the illumination device 200. The rest configuration of the steering wheel 100a in the second embodiment is same to the steering wheel 100 in the first embodiment. Therefore, the same reference numerals denote the same structure, and a detailed description thereof will be omitted.

The illumination device 200a in the second embodiment differs from the illumination device 200 in that it includes the light guide 20a instead of the light guide 20, the light-emitting unit 30a instead of the light-emitting unit 30, and the lens unit 40a instead of the lens unit 40.

The light-emitting unit 30a comprises a pair of the first LED 36 instead of a plurality of the first LED 32. A pair of the first LED 36 emit visible-light, same as the first LED 32 of the first embodiment. A pair of the first LED 36 is disposed respectively on the left and right end portions in the circumferential direction of the substrate 31. Unlike the first LED 32, the first LED 36 emits visible light along the circumferential direction in a direction toward the other the first LED 36.

As shown in FIG. 5, the light guide 20a is disposed between a pair of the first LED 36 along the circumferential direction. The light guide 20a has an arc-shaped and strip-shaped look curved along the circumference, as viewed from the driver. The light guide 20a, like the light guide 20 in the first embodiment, guides the visible-light emitted from a pair of the first LED 36 to the lens unit 40a. Both right and left end surfaces in the circumferential direction of the light guide 20a faces the exit surface of the pair of the first LED 36. Visible light emitted from the first LED 36 (emitted light) diffuses circumferentially while repeatedly reflecting in the light guide 20a. Further, on the surface of the substrate 31 of the light guide 20a, a large number of the groove for deflecting the emitted light to the backward direction is formed. Therefore, the backward direction end surface of the light guide 20a toward the lens unit 40a is emitted.

As shown in FIG. 6, the lens unit 40a of the second embodiment differs from the lens unit 40 of the first embodiment in that it has the groove 43a instead of the groove 43. The groove 43a is a groove whose depth direction corresponds to the longitudinal direction. The groove 43a are formed in an arc shape when viewed in the longitudinal direction, as in the light guide 20a. The groove 43a accommodates the light guide 20a.

The steering wheel 100a of the second embodiment described above has similar effect to the steering wheel 100 in the first embodiment.

### C. Third Embodiment

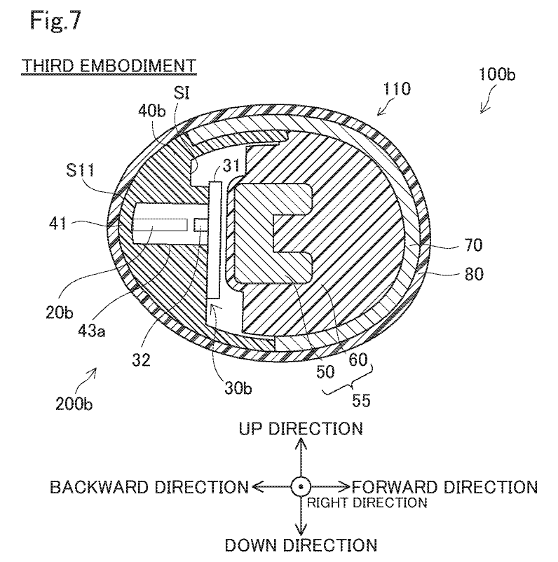

FIG. 7 is a sectional view showing a cross section of the steering wheel 100b of the third embodiment. FIG. 7 shows the cross-section of the steering wheel 100b at the same position as FIG. 4.

The steering wheel 100b in the third embodiment differs from the steering wheel 100 in the first embodiment in that it has the illumination device 200b instead of the illumination device 200. The rest of configuration of the steering wheel 100b in the third embodiment is same to the steering wheel 100 in the first embodiment. Therefore, the same reference numerals denote the same structure, and a detailed description thereof will be omitted.

The illumination device 200b in the third embodiment differs from the illumination device 200 in that it includes the light guide 20b instead of the light guide 20, the light-emitting unit 30b instead of the light-emitting unit 30, and the lens unit 40b instead of the lens unit 40.

The light guide 20b of the third embodiment differs from the light guide 20 of the first embodiment in that the first light passage 21 and the deflection portion 23 is omitted, and instead, only the second optical path portion 22 is equipped. The light guide 20 is supported by an engaging claw (not shown) provided in the lens unit 40b. Instead of the lens unit 40b, it may be supported is engaged by the claw provided in advance in the substrate 31.

The light-emitting unit 30b differs from the first embodiment of the light-emitting unit 30 in that the arrangement positions of the plurality of the first LED 32 in the substrate 31 are slightly above along the radial direction, and in that the emission directions of the visible lights of the plurality of the first LED 32 are the forward direction. The other configuration of the light-emitting unit 30b is the same as the light-emitting unit 30. The light guide 20b is disposed to face the exit surface of the emitted light in a plurality of the first LED 32.

The lens unit 40b differs from the lens unit 40 in the first embodiment in that it has the same the groove 43a as the groove 43a in the second embodiment in place of the groove 43. The other configurations of the lens unit 40b is the same as the lens unit 40.

The steering wheel 100b of the third embodiment described above has similar effect to the steering wheel 100 in the first embodiment.

### D. Fourth Embodiment

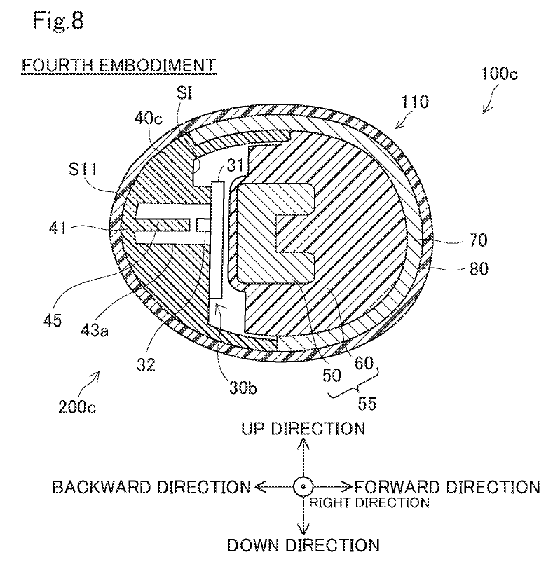

FIG. 8 is a sectional view showing a cross section of the steering wheel 100c of the fourth embodiment. FIG. 8 shows the cross-section of the steering wheel 100c at the same position as FIG. 3.

The steering wheel 100c of the fourth embodiment differs from the steering wheel 100b of the third embodiment in that it has the illumination device 200c instead of the illumination device 200b. The rest of configuration of the steering wheel 100c in the fourth embodiment is same as that of the steering wheel 100b of the third embodiment. Therefore, the same reference numerals denote the same structure, and a detailed description thereof will be omitted.

The illumination device 200c of the fourth embodiment differs from the illumination device 200b of the third embodiment shown in FIG. 7 in that the light guide 20b is omitted and the lens unit 40c is provided instead of the lens unit 40b. the other configuration of the illumination device 200c is the same as the illumination device 200b.

The lens unit 40c of the fourth embodiment is different from the lens unit 40b of the second embodiment in that it includes the light guide 45. The other configuration of the lens unit 40c is same as the lens unit 40b. The light guide 45 is formed as a arcuate walls in plain view and cantilevered and protruded in the groove 43a. The light guide 45 has the same geometry as the light guide 20b of the third embodiment and is also located in the same position. That is, the light guide 45 differs from the light guide 20b of the third embodiment only in that it is integrally formed with the lens unit 40c.

The steering wheel 100c of the fourth embodiment described above has similar effect to the steering wheel 100 in the first embodiment and the steering wheel 100b of the third embodiment. In addition, the lens unit 40c and the light guide 45 are integrally formed. In this specification, “element P and element Q are integrally formed” means that there is no physical boundary between element P and element Q. Therefore, as compared with the configuration which is formed as a separate member respectively, it is possible to reduce the loss of light at the boundary portion, and possible to facilitate the assembling operation. In this specification, the expression “members A and B are integrated” means that separately formed members A and B are fixed to each other.

### E. Fifth Embodiment

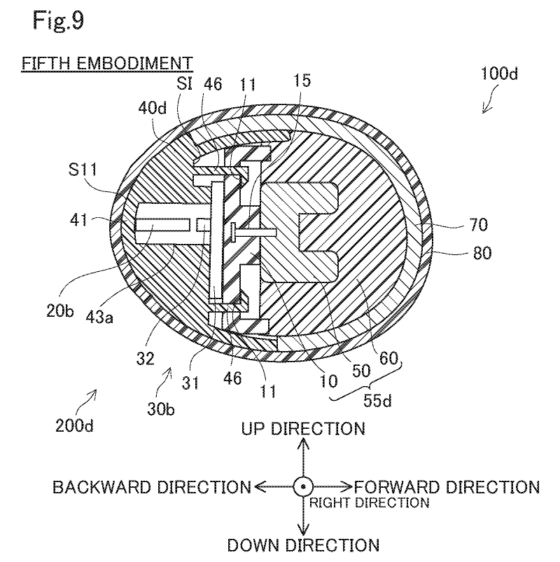

FIG. 9 is a sectional view showing a cross section of the steering wheel 100d of the fifth embodiment. FIG. 9 shows the cross-section of the steering wheel 100d at the same position as FIG. 3.

The steering wheel 100d in the fifth embodiment differs from the steering wheel 100b in the third embodiment in that it includes the illumination device 200d instead of the illumination device 200b and a support 55d instead of the support 55. The other configuration of the steering wheel 100d in the fifth embodiment is same as that of the steering wheel 100b of the third embodiment. Therefore, the same reference numerals denote the same structure, and a detailed description thereof will be omitted.

The illumination device 200d differs from the illumination device 200b of the third embodiment shown in FIG. 7 in that it has the lens unit 40d instead of the lens unit 40b. The illumination device 200d differs from the illumination device 200b in that it comprises a plurality of the second engaging portion 46. The other configuration of the illumination device 200d is same as the illumination device 200b.

The second engaging portion 46 is engaged with the first engaging portion 11 (described later) provided in the supporting portion 55d corresponding to the intermediate member 10 to be described later. The first engaging portion 11 and he second engaging portion 46 are positioned so that they do not interfere with the optical path of the light emitted from the first LED 32. In the present embodiment, as shown in FIG. 9, the second engaging portion 46 is constituted by a claw protruding from the end of the lens unit 40d on the forward direction side to the forward direction side. The second engaging portions 46 extend to the forward direction at the up direction side and the down direction side positions from relative to the substrate 31. In the present disclosure, the second engaging portion 46 is also referred to as an "engaging claw."

The support 55d differs from the support 55 of the third embodiment in that it includes the intermediate member 10 and that the shock absorbing unit 60 does not cover the backward direction end face of the core metal 50. The intermediate member 10 is a member interposed between the lens unit 40d and the core metal 50. The intermediate member 10 is a resin-made member is fixed to the core metal 50 by the screws 15. The intermediate member 10 comprises a plurality of the first engaging portion 11. The first engaging portion 11 engages the second engaging portion 46 of the lens unit 40d as described above. By the first engaging portion 11 and the second engaging portion 46 are engaged with each other, the lens unit 40d is fixed to the core metal 50 through intermediate member 10. With this configuration, in order to fix the lens unit 40d to the support portion 55d, it is not necessary to place the member for fixing in the vertical central portion. Therefore, the fixing member on the optical path of the emitted light from the first LED 32 can avoid becoming an obstacle.

The steering wheel 100d of the fifth embodiment described above has similar effect to the steering wheel 100b of the third embodiment and the steering wheel 100 of the first embodiment. In addition, when assembling the steering wheel 100d, the intermediate member 10 may be first secured to the core metal 50 with the screws 15, followed by engagement of the lens unit 40d and the intermediate member 10. Accordingly, contrary to the configuration in which the lens unit 40d is screwed to the core metal 50 directly, it is not necessary to provide a hole for the screws in the lens unit 40d and the lid unit for blocking such holes. Therefore, it is possible to prevent unevenness from occurring between the lid unit and the hole. Therefore, it is possible to prevent unevenness from occurring between such the lid unit and the hole. The core metal 50 is centered on the gripping portion 110. Accordingly, the fixing screw is to be placed in the center of the lens unit 40d. In the steering wheel 100d of the fifth embodiment, it is possible to avoid the presence of such an obstacle in the optical path of the light emitted from the first LED 32.

### F. Sixth Embodiment

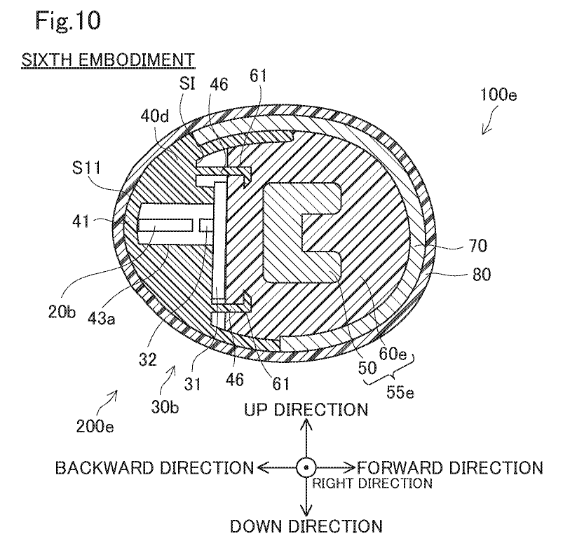

FIG. 10 is a sectional view showing a cross section of the steering wheel 100e of the sixth embodiment. FIG. 10 shows the cross-section of the steering wheel 100e at the same position as FIG. 3.

The steering wheel 100e of the sixth embodiment differs from the steering wheel 100d of the fifth embodiment shown in FIG. 9 in that the intermediate member 10 and the screws 15 are omitted, and that it comprises a support 55e in place of the support portion 55. The other configuration of the steering wheel 100e is same as the steering wheel 100d.

The support 55e differs from the fifth embodiment support 55d in that it has the shock absorbing unit 60e instead of the shock absorbing unit 60. The shock absorbing unit 60e differs from the shock absorbing unit 60 in the fifth embodiment in that it covers the backward direction end of the core metal 50 and comprises a plurality of the engaging hole 61 that engage a plurality of the second engaging portion 46 provided in the lens unit 40d. The engaging hole 61 is configured as the engaging hole into which the second engaging portion 46 is inserted and engaged with the second engaging portion 46. In the sixth embodiment, by engaging the second engaging portion 46 and the engaging hole 61 with each other, the lens unit 40d is fixed to the support portion 55e.

The sixth embodiment does not require the screws 48 as shown in FIG. 3 for fixing to the support portion 55e of the lens unit 40d. Therefore, there is no need to form the through hole 47 in the lens unit 40 and providing the lid unit 49. Therefore, it is possible to suppress the driver to feel unevenness due to the through hole 47.

According to the steering wheel 100e of the sixth embodiment described above, it achieves the same advantages as the steering wheel 100d of the steering wheel 100 and the fifth embodiment of the first embodiment. In addition, the intermediate member 10 is omitted. Therefore, as compared with the configuration in which the intermediate member 10 is present, it is possible to realize a reduction in size and weight of the gripping portion 110. The lens unit 40d also has the second engaging portion (engaging claw) 46 for engaging the shock absorbing unit 60e. The second engaging portion (engaging claw) 46 of the lens unit 40d is positioned so that it does not interfere with the optical path of the light emitted from the first LED 32. Accordingly, in the steering wheel 100e of the sixth embodiment, contrary to the configuration in which the lens unit 40d is screwed to the core metal 50 directly, it is not necessary to provide a hole for the screws in the lens unit 40d and the lid unit for blocking such holes. Therefore, it is possible to prevent unevenness from occurring between such the lid unit and the hole. The core metal 50 is generally located in the center of the gripping portion 110. Accordingly the fixing screw is to be placed in the center of the lens unit 40d. However, in this aspect of the steering wheel, it is possible to avoid the presence of an obstacle on the optical path of the light from the plurality of the first LED 32.

### G. Seventh Embodiment

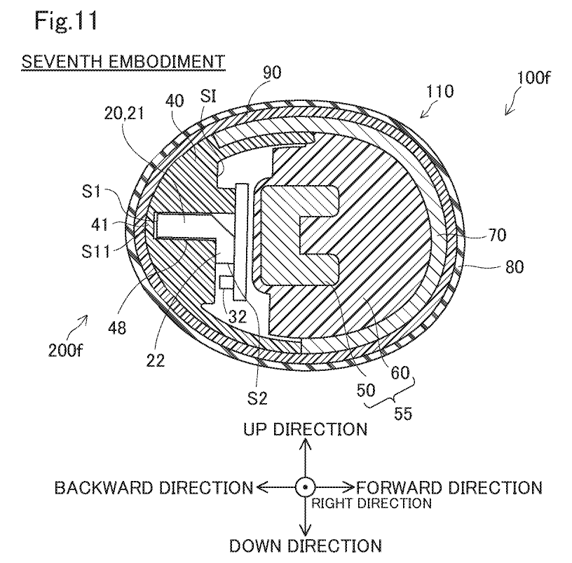

FIG. 11 is a sectional view showing a cross section of the steering wheel 100f of the seventh embodiment. FIG. 11 shows the cross-section of the steering wheel 100f at the same position as FIG. 3.

The steering wheel 100f of the seventh embodiment differs from the steering wheel 100 of the first embodiment shown in FIG. 4 in that it includes the second lens unit 90. The other configuration of the steering wheel 100f is same as the steering wheel 100. In the seventh embodiment, the lens unit 40 is referred to as a "the first lens unit 40" for convenience.

The second lens unit 90 is a pipe-shaped member having a transmissivity to the emitted light. When viewed longitudinal direction, the second lens unit 90 has the external form of an arc. The second lens unit 90 in the gripping portion 110 is disposed in contact with the outer surfaces of the first lens unit 40 and the element layer 70, and surround over the entire of the first lens unit 40 and the element layer 70. Thus, the second lens unit 90 is disposed over the outer surface S11 (i.e. contiguous surface) of the first lens unit 40. Further, in the second lens unit 90, the part covering the outer surface S11 has an arcuate continuously outer shape in the cross section of FIG. 11.

In the seventh embodiment, the first lens unit 40 is made of acryl-resin. On the other hand, the second lens unit 90 is formed of a PC resin. The second lens unit 90 is closer to the outside of the steering wheel 100f. Accordingly, in order to ensure a protective function, it is formed of a PC having a relatively high-rigidity. The first lens unit 40, on the other hand, is protected by the first lens unit 40 which is located inside the second lens unit 90. Accordingly, in the seventh embodiment, the first lens unit 40 is formed using a cheaper and lighter acrylic resin.

In the seventh embodiment, the outer skin layer 80 is disposed over the entire the outer surface of the second lens unit 90. The outer surface of the second lens unit 90 to which the outer skin layer 80 is in direct contact is a smooth, contiguous surface throughout. Therefore, the driver is suppressed from feeling irregularities through the outer skin layer 80.

The steering wheel 100f of the seventh embodiment described above achieves the same advantages as the steering wheel 100 of the first embodiment. In addition, it comprises the second lens unit 90 disposed over the outer surface S11 (continuum) of at least the first lens unit 40. Therefore, the second lens unit 90 can reinforce the first lens unit 40. Further, the material of the second lens unit 90 on the outer side is made of a PC resin having a larger stiffness to improve strength, and the material of the first lens unit 40 is made of an acrylic resin which is a cheaper material. Therefore, it is possible to suppress an increase in the manufacturing cost of the steering wheel 100f. Further, in the second lens unit 90, the part covering the outer surface S11 (contiguous surface) has an arcuate contiguous outer shape in a cross section parallel to the axial direction of the steering wheel 100f. Therefore, the outer shape of the gripping portion 110, it can be easily gripped by the driver.

### H. Other Embodiments

(H1) In the respective embodiments, the lens unit 40 and 40a~40d support the substrate 31, but may not support the substrate 31. Even in such an arrangement, the lens unit 40 and 40a~40d accommodate the substrate 31 in a manner in which the inner surface SI faces the substrate 31.

(H2) In the respective embodiments, the lens unit 40, 40a~40d is provided with the light transmitting portion 41 and the low transmissivity portion 42, but the lens unit may comprise only the light transmitting portion 41 without the low transmissivity portion 42.

(H3) The configuration of the steering wheel 100 and 100a~100f of the embodiments are only examples. The configuration can be variously changed. For example, in each embodiment, the number of the first LED 32 and the second LED 33 may be any number. Further, for example, in the respective embodiments, a plurality of the second LED 33 may be omitted. Further, for example, in the respective embodiments, the outer skin layer 80 may be omitted.

### I. Other Aspects

(1) As one aspect of the present disclosure, a steering wheel is provided.

A steering wheel in this aspect comprises: a gripping portion; a substrate disposed in the grip portion, wherein a light emitting element is provided on the substrate; and a lens unit disposed in the grip portion, wherein the lens unit comprises a light transmitting portion that has a transmissivity to a light emitted from the light emitting element and emits the light to the outside of the grip portion, wherein the lens unit accommodates the substrate such that an inner surface of lens unit faces the substrate. The lens unit has an outer surface on a side facing a user of the steering wheel. The outer surface is composed of a contiguous surface which includes a part of a surface of the light transmitting portion.

In this aspect of the steering wheel, the lens unit has the outer surface composed of a contiguous surface that includes a part of the surface of the light transmitting portion on the side facing the user (i.e., the driver) of the steering wheel. Therefore, in any of the configuration in which the outer surface is the gripping portion and the configuration in which the outer layers (e.g., the outer skin layer) are formed further along the outer surface, it is possible to suppress the driver from feeling unevenness when touching the gripping portion.

(2) In the steering wheel of the above aspect, the lens unit may support the substrate.

This aspect of the steering wheel supports the substrate for the lens unit. Accordingly, the lens unit as a single part can be used to realize both of (i) a part that has a function to emit light to the outside of the gripping portion and a function to accommodate the substrate and (ii) a part that has a function to support the substrate. Accordingly, compared with a configuration in which these functions are realized by different parts, the number of components can be reduced, the assembly operation can be simplified, and the weight of the steering wheel can be reduced.

(3) In the steering wheel of the above aspect, the lens unit may comprise a low transmissivity portion adjacent to the light transmitting portion. The low transmissivity portion may have a lower light transmissivity than the light transmitting portion. A surface of the light transmitting portion and a surface of the low transmissivity portion may form a part of the contiguous surface, and may be arranged in contact with each other in the contiguous surface.

In the steering wheel of this aspect, the surface of the light transmitting portion and the surface of the low transmissivity portion form a part of the contiguous surface, and are arranged in contact with each other in the contiguous surface. Therefore, it is possible to suppress the unevenness at the border between the transmission unit and the low transmissivity portion.

(4) In the steering wheel of the above aspect, when the lens unit is referred to as a first lens unit, the steering wheel may further comprise a second lens unit having the transmissivity to the light. The second lens unit may be disposed over at least the contiguous surface of the first lens unit. A part covering the contiguous surface in the second lens unit may have an arcuate contiguous outer shape in a cross section parallel to a direction of an axis of the steering wheel.

This aspect of the steering wheel comprises the second lens unit located at least over the continuum of the first lens unit. Therefore, the first lens unit can be reinforced by the second lens unit. In addition, the first lens unit material can be different from the second lens unit material. Therefore, for example, by adopting more rigid material as the material of the second lens unit which is disposed outside, the strength of the steering wheel can be increased. By adopting a more inexpensive material as the material of the first lens unit the increase in the steering wheel's manufacturing costs can be suppressed. Further, the part covering the contiguous surface has the arcuate contiguous outer shape in a cross section parallel to the direction of the axis of the steering wheel. Therefore, the external shape of the gripping portion can be easily grasped by the driver.

(5) In the steering wheel of the above aspect, the steering wheel may further comprise a light guide for guiding the light emitted from the light emitting element to the light transmitting portion. The light guide may be arranged in contact with the lens unit. The lens unit and the light guide may be integrally formed.

This aspect of the steering wheel comprises the light guide. Therefore, the amount of light (brightness) emitted from the light transmitting portion to the outside can be increased. In addition, the lens unit and the light guide are integrally formed. Therefore, as compared with the configuration in which the lens unit and the light guide are formed as separate members respectively, it is possible to reduce the loss of light at the boundary portion, and it is possible to facilitate the assembling operation.

(6) In the steering wheel of the above aspect, the steering wheel may further comprise: an outer skin layer covering at least the contiguous surface. The outer skin layer may have a transmissivity to the light and forms an outermost layer in the grip portion.

The steering wheel of this aspect further comprises the outer skin layer which has transmissivity to the light and forms the outermost layers in the gripping portion. Therefore, it is possible to improve the tactile feeling by the outer skin layer, also improves the decorative property. For example, in a configuration in which the steering wheel comprises a light guide for guiding the light emitted from the light emitting element to the light transmitting portion. The light guide is arranged in contact with the lens unit, and the lens unit and the light guide are integrally formed, the following events may occur. That is, there is a possibility that, when the lens unit and the light guide are integrally formed by injection molding, a so-called "sink" may occur in a part of the lens unit corresponding to the part where the light guide is connected to the lens unit on the rear surface. However, the outer skin layer as the outermost layer can reduce the possibility that the driver feels such sink marks as irregularities.

(7) In the steering wheel of the above aspect, the steering wheel may further comprise: a core metal as a framework of the gripping portion; and an intermediate member bolted to the core metal. The intermediate member may comprise a first engaging portion for engaging the lens unit. The lens unit may comprise a second engaging portion for engaging the first engaging portion.

This aspect of the steering wheel has an intermediate member that is bolted to the core metal, while the lens unit has a second engaging portion to engage the first engaging portion of the intermediate member. Accordingly, when assembling the steering wheel, the intermediate member is first fixed to the core metal with the screws, and then the lens unit and the intermediate member are engaged. When the lens unit is fixed to the core metal by direct the screws, the lens unit must be provided with a hole through which the screw passes. After the lens unit is fixed to the core metal, the hole must be blocked by the lid unit. Therefore, unevenness occurs between the member around the hole and the lid unit. However, in the above-described the steering wheel, the lens unit is attached to the steering wheel by engaging the intermediate member. Therefore, the lens unit can be attached to the steering wheel without providing irregularities.

Generally, the core metal is located in the center of the gripping portion. Therefore, in the configuration where the lens unit is fixed directly to the core metal by the screws, the screws for fixing is placed in the center of the lens unit, and the screws as obstacles exist in the optical path of the light from the light emitting device. In the above-described the steering wheel, the lens unit is fixed with respect to the core metal via the intermediate member. Therefore, it is possible to avoid the presence of the obstacles on the optical path of the light from the light emitting element.

(8) In the steering wheel of the above aspect, the steering wheel may further comprise: a core metal as a framework of the gripping portion; and a shock absorbing unit disposed to cover at least a part of the core metal. The lens unit may have an engaging claw for engaging the shock absorbing unit.

When the lens unit is fixed directly to the core metal by the screws, the lens unit must be provided with a hole through which the screws passes. After the lens unit is fixed to the core metal, the hole must be blocked by the lid unit. Therefore, unevenness occurs between the member around the hole and the lid unit. However, in the above-described the steering wheel, the lens unit is attached to the steering wheel by engaging the shock-absorbing section. Therefore, the lens unit can be attached to the steering wheel without providing irregularities.

Generally, the core metal is located in the center of the gripping portion. Therefore, in the configuration where the lens unit is fixed directly to the core metal by the screws, the screws for fixing is placed in the center of the lens unit, and the screws as obstacles exist in the optical path of the light from the light emitting device. However, in the above-described the steering wheel, the lens unit is fixed with respect to the core metal via the shock-absorbing section. Therefore, it is possible to avoid the presence of obstacles on the optical path of the light from the light emitting element.

The present disclosure is not limited to each of the embodiments described above and is able to be realized with various configurations without departing from the spirit thereof. For example, technical features in the embodiments corresponding to the technical features in the aspects described in the section of SUMMARY are able to be replaced with each other or combined together, as appropriate, in order to solve part or the whole of the problems described previously or to achieve part or the whole of the effects described previously. When the technical features are not described as essential features in the present specification, they are able to be deleted, as appropriate. For example, the present disclosure may be realized in aspects described below.

What is claimed is:

1. A steering wheel comprising:
a gripping portion;
a substrate disposed in the grip portion, wherein a light emitting element is provided on the substrate; and
a lens unit disposed in the grip portion, wherein the lens unit comprises a light transmitting portion that has a transmissivity to a light emitted from the light emitting element and emits the light to the outside of the grip portion, wherein the lens unit accommodates the substrate such that an inner surface of lens unit faces the substrate,
wherein the lens unit has an outer surface on a side facing a user of the steering wheel, wherein the outer surface is composed of a contiguous surface which includes a part of a surface of the light transmitting portion.

2. The steering wheel according to claim 1, wherein the lens unit supports the substrate.

3. The steering wheel according to claim 1, wherein the lens unit comprises a low transmissivity portion adjacent to the light transmitting portion, wherein the low transmissivity portion has a lower light transmissivity than the light transmitting portion,
wherein a surface of the light transmitting portion and a surface of the low transmissivity portion form a part of the contiguous surface, and are arranged in contact with each other in the contiguous surface.

4. The steering wheel according to claim 1, wherein when the lens unit is referred to as a first lens unit,
the steering wheel further comprises a second lens unit having the transmissivity to the light,
the second lens unit is disposed over at least the contiguous surface of the first lens unit,
wherein a part covering the contiguous surface in the second lens unit has an arcuate contiguous outer shape in a cross section parallel to a direction of an axis of the steering wheel.

5. The steering wheel according to claim 1, wherein further comprising a light guide for guiding the light emitted from the light emitting element to the light transmitting portion, wherein the light guide is arranged in contact with the lens unit,
wherein the lens unit and the light guide are integrally formed.

6. The steering wheel according to claim 1, further comprising:
an outer skin layer covering at least the contiguous surface, wherein the outer skin layer has a transmissivity to the light and forms an outermost layer in the grip portion.

7. The steering wheel according to claim 1, further comprising:
a core metal as a framework of the gripping portion; and
an intermediate member bolted to the core metal, wherein the intermediate member comprises a first engaging portion for engaging the lens unit,
wherein the lens unit comprises a second engaging portion for engaging the first engaging portion.

8. The steering wheel according to claim 1, further comprising:
a core metal as a framework of the gripping portion; and
a shock absorbing unit disposed to cover at least a part of the core metal,
wherein the lens unit has an engaging claw for engaging the shock absorbing unit.
